(19) United States
(12) Patent Application Publication
(10) Pub. No.: US 2024/0343918 A1
(43) Pub. Date: Oct. 17, 2024

(54) Method for Reducing or Eliminating the Carry Back of Aggregate Material by Hauling Equipment

(71) Applicant: Natural Alternatives, LLC, Lexington, KY (US)

(72) Inventor: Todd Bloomer, Lexington, KY (US)

(21) Appl. No.: 18/752,212

(22) Filed: Jun. 24, 2024

Related U.S. Application Data
(63) Continuation-in-part of application No. 18/142,325, filed on May 2, 2023.
(60) Provisional application No. 63/337,835, filed on May 3, 2022.

(51) Int. Cl. C09D 5/16

(52) U.S. Cl. CPC C09D 5/1656

(57) ABSTRACT

A method for reducing aggregate material carry back in aggregate material hauling equipment includes applying an effective amount of an anti-sticking and anti-icing agent to hauling surfaces of the aggregate material hauling equipment that will subsequently be in contact with the aggregate material to be hauled. The method includes initiating loading of the aggregate material into the aggregate material hauling equipment while the hauling surfaces of the hauling equipment remain wet from the applying of the anti-sticking and anti-icing agent. This ensures wetting of the aggregate material at the interface with the hauling surface to provide improved anti-sticking and anti-icing action.

### RELATED APPLICATIONS

This application is a continuation-in-part (CIP) of U.S. patent application Ser. No. 18/142,325 filed on May 2, 2023, which claims priority to U.S. provisional Patent Application Ser. No. 63/337,835, filed on May 3, 2022, the full disclosures of which are hereby incorporated by reference.

### TECHNICAL FIELD

This document relates generally to the field of aggregate material transport and, more particularly, to a method and agent adapted for treating aggregate material and aggregate material equipment to reduce or eliminate the carry back of aggregate material which has been a longstanding and prevalent problem for aggregate material haulers.

### BACKGROUND

Aggregate materials of all types (e.g. sand, gravel, coal, fuel pellets, fuel briquettes, coke and iron ore) are often transported in mass quantities to industrial facilities, such as product processing plants, concrete companies, steel mills and power plants, in open top hoppers/rail cars, dump trucks and open top truck trailers. Not only are these aggregate materials exposed to the elements during their transport but they are often loaded into the open hoppers, rail cars, dump trucks and open top truck trailers from storage piles that are also exposed to the elements.

Once the aggregate materials reach their destination, they are dumped from the open top hoppers, rail cars, dump trucks and open top trailers. For example, many coal fired power plants have rotary dumpers that are designed to roll the rail car over to dump the load of coal or fuel pellets. As a result of the exposure of the aggregate materials to rain, snow and ice, the aggregate materials, particularly when temperatures fall below freezing, may have a tendency to clump together and at times have a tendency to stick in the hopper, rail car, dump truck or open top trailer.

The aggregate material that does not dump from the open top hopper, rail car, dump truck or trailer is often referred to as “carry back”. The carry back material can accumulate over time and become a significant concern where the open hoppers, rail cars, dump trucks and truck trailers are used over and over again to carry the same aggregate materials from a source of supply to an end user. For example, carry back coal that accumulates in the bottom of a rotary dump rail car may consume as much as 2-7 tons of the capacity of a 100 ton rail car. Thus, each aggregate material load delivered by the rail car is reduced by 2-7%. In the case of a coal fired power plant receiving a 100 rail car shipment, such carry back numbers could mean a coal delivery shortfall of between 200-700 tons. Such a shortfall can have a significant effect on the operations of the utility power plant.

In the past it has been suggested to spray the aggregate material with an anti-icing agent after it has been loaded into a rail car in order to prevent the clumping of aggregate materials (See U.S. Pat. No. 6,878,308 to Schilling). Such an approach has proven to be relatively ineffective in controlling the sticking of aggregate materials in hauling equipment and the resulting carry back continues to be a problem adversely effecting transport and operating efficiencies.

This failure is primarily due to the large volume and massive surface area of the aggregate material between the anti-icing agent and the contact surfaces of the hauling equipment at the time of spraying. The relatively high viscosity of the anti-icing agents in cold temperatures near and below freezing (32° F./0° C.) further complicates the issue by slowing penetration of the deicing agent through the aggregate material toward the surfaces of the hauling equipment in contact with the aggregate material. Any effort to address and resolve the carry back issue with this prior art approach of spraying the aggregate material after loading would simply require the application of prohibitive quantities of deicing agent rendering such an effort economically and environmentally unfeasible. As a result, the carry back problem remains largely unresolved by the transportation industry.

This document relates to a new and improved method and agent for (a) treating aggregate material hauling equipment, such as open hoppers, rail cars, dump trucks and open top truck trailers, and (b) preventing clumping and sticking of aggregate materials in the open hoppers, rail cars, dump trucks or open top truck trailers in which they are transported to a user.

### SUMMARY

In accordance with the purposes and benefits described herein, a new and improved method for reducing aggregate material carry back in aggregate material hauling equipment comprises applying an effective amount of an anti-sticking and anti-icing agent to hauling surfaces of the aggregate material hauling equipment that will subsequently be in contact with the aggregate material to be hauled.

The anti-sticking and anti-icing agent is selected from a group of materials consisting of corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof

The method may further include using as the anti-sticking and anti-icing agent a material having (a) a viscosity of about 25 secs with a Zahn #2 cup, (b) a pH of about 6.8 to about 9.7 and (c) non-corrosive properties.

In one or more of the many possible embodiments of the method, the applying is performed by spraying the hauling surfaces of the aggregate material hauling equipment that will subsequently be in contact with the aggregate material: that is, applying before loading the hauling equipment with the aggregate material. The applying may include lowering a spray applicator into a hauling compartment of the aggregate material hauling equipment and moving the spray applicator relative to the aggregate material hauling equipment until all of the hauling surfaces that will contact the aggregate material during hauling are coated with the anti-sticking and anti-icing agent. Where the aggregate material hauling equipment is a rail car, the method may include spraying at a rate of about 5-20 gallons per rail car.

In one or more of the many possible embodiments of the method, the method includes the additional step of applying the anti-sticking and anti-icing agent to the aggregate material at a rate of about 2-6 pints per ton of aggregate material.

In some embodiments, the method includes applying the anti-sticking and anti-icing agent to the aggregate material before it is loaded into the aggregate material hauling equipment. Still further, the method may include applying the anti-sticking and anti-icing agent to the aggregate material before it is stored in a stock pile for subsequent loading into the aggregate material hauling equipment. In some embodiments, the method may include applying the anti-sticking and anti-icing agent to the aggregate material during transfer from the stockpile to the aggregate material hauling equipment. In some embodiments, the method may include applying the anti-sticking and anti-icing agent to the aggregate material after loading into the aggregate material hauling equipment.

In some embodiments, the method further includes initiating loading of the aggregate material into the aggregate material hauling equipment while the hauling surfaces of the hauling equipment remain wet from the application of the anti-sticking and anti-icing agent. This may include initiating loading of the aggregate material into the aggregate material hauling equipment within five minutes of the applying of the anti-sticking and anti-icing agent. In an alternative, this may include initiating loading of the aggregate material into the aggregate material hauling equipment within one minute of the applying of the anti-sticking and anti-icing agent.

### DETAILED DESCRIPTION

The new and improved method for reducing aggregate material carry back in aggregate material hauling equipment, comprises applying an effective amount of an anti-sticking and anti-icing agent to hauling surfaces of the aggregate material hauling equipment that will subsequently be in contact with the aggregate material to be hauled. In other words, those hauling surfaces are coated with the anti-sticking and anti-icing agent before the aggregate material is loaded into the hauling equipment.

The anti-sticking and anti-icing agent used to treat the aggregate material hauling equipment to prevent clumping and sticking preferably has a viscosity of about 25 secs with a Zahn #2 cup, a pH of about 6.8 to about 9.7 and non-corrosive properties so that it will not damage the hauling equipment over time. The anti-sticking and anti-icing agent should also be environmentally friendly. Materials useful as the anti-sticking and anti-icing agent include corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof.

While total water content can vary from 1-99 wt %, the solution typically has 30-80 wt % solids, 70-20 wt % water, a pH of 5 to 11 and the sugars will vary between 10-70 wt %. In one particularly useful embodiment, the solution may have solids around 50%.

In one possible embodiment, the solution is made by blending the anti-sticking and anti-icing agent with glycerin, a formate, or an acetate and adding water to reduce the viscosity. The viscosity is very important because the material will be used in freezing temps. If not blended properly the solution will not be sprayable. The solution will have the capabilities of sticking to the aggregate and/or steel/aluminum aggregate contact surfaces of the hauling equipment and not drain, run down or release from the surface upon which it is applied. The solution will have the characteristics of being able to be pumped in cold weather and being able to stick in warmer weather. The solution should be of non-chloride and be non-corrosive to metal surfaces.

In at least one possible embodiment, the applying is performed by spraying the hauling surfaces of the open hopper, rail car, dump truck and open top truck trailer that will subsequently be in contact with the aggregate material; that is, the anti-sticking and anti-icing agent is applied or sprayed on before the aggregate material is loaded into the open hopper, rail car, dump truck or open top trailer.

Toward this end, a spray applicator of substantially any appropriate shape (e.g. elongated bar, egg) may be used to spray the hauling surfaces inside the hauling compartment of the aggregate material hauling equipment. In one possible embodiment, the spray applicator is lowered into the hauling compartment and moved relative to the aggregate material hauling equipment until all of the hauling surfaces that will contact the aggregate material during hauling are coated with the anti-sticking and anti-icing agent. In at least one possible embodiment, an effective amount of the anti-sticking and anti-icing agent is applied by spraying at a rate of between about 5-20 gallons per rail car.

The anti-sticking and anti-icing agent may also be applied to the aggregate material at the rate of about 2-6 pints per ton of aggregate material. This application to the aggregate material may take place before storing in a stock pile, during transfer from the stock pile to the aggregate material hauling equipment and/or after delivery to the aggregate material hauling equipment.

The anti-sticking and anti-icing agent is essentially chloride free and as a result is non-corrosive to the aggregate material hauling equipment. This is also a particularly significant aspect of the agent for the utility industry as application of the agent effectively adds no chlorides to the coal, fuel pellets and fuel briquettes to be burned to generate power. Thus, chloride induced corrosion of power plant equipment, and the environmental concerns inherent in the burning of chloride containing materials (e.g. formation of chlorine, hydrochloric acid and other toxic chloride compound during incineration) are avoided.

In at least one possible embodiment, the anti-sticking and anti-icing agent is applied to the hauling surfaces of the aggregate material hauling equipment immediately before the aggregate material is loaded into the hauling equipment. In at least one possible embodiment, loading of the aggregate material into the hauling equipment is initiated while the hauling surfaces of the hauling equipment remain wet from the application of the anti-sticking and anti-icing agent. This ensures wetting of the aggregate material with the anti-sticking and anti-icing agent at the interface between the aggregate material and the coal hauling surface thereby providing the most effective anti-sticking and anti-icing action.

In at least one possible embodiment, loading of the aggregate material into the hauling equipment is initiated within five minutes of applying the anti-sticking and anti-icing agent to the hauling surfaces. In at least one possible embodiment, loading of the aggregate material is initiated within one minute of applying the anti-sticking and anti-icing agent to the hauling surfaces.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an anti-sticking and anti-icing agent”, as used herein, may also refer to, and encompass, a plurality of such agents.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. The phrase “consisting of”, as used herein, is closed-ended and excludes any element, step, or ingredient not specifically mentioned. Terms of approximation, such as the terms about, substantially, approximately, etc., as used herein, refers to ±10% of the stated numerical value.

Although the method of this disclosure has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A method for reducing aggregate material carry back in aggregate material hauling equipment, comprising:
applying an effective amount of an anti-sticking and anti-icing agent to hauling surfaces of the aggregate material hauling equipment that will subsequently be in contact with the aggregate material to be hauled wherein the anti-sticking and anti-icing agent is a material selected from a group consisting of corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof.

2. The method of claim 1, including using as the anti-sticking and anti-icing agent a material having (a) a viscosity of about 25 secs with a Zahn #2 cup, (b) a pH of about 6.8 to about 9.7 and (c) non-corrosive properties.

3. The method of claim 1, wherein the applying is performed by spraying the hauling surfaces of the aggregate material hauling equipment that will subsequently be in contact with the aggregate material.

4. The method of claim 1, wherein the applying includes lowering a spray applicator into a hauling compartment of the aggregate material hauling equipment and moving the spray applicator relative to the aggregate material hauling equipment until all of the hauling surfaces that will contact the aggregate material during hauling are coated with the anti-sticking and anti-icing agent.

5. The method of claim 4, further including spraying at a rate of about 5-20 gallons per rail car.

6. The method of claim 1, further including applying the anti-sticking and anti-icing agent to the aggregate material at a rate of about 2-6 pints per ton of aggregate material.

7. The method of claim 1, further including applying the anti-sticking and anti-icing agent to the aggregate material before it is loaded into the aggregate material hauling equipment.

8. The method of claim 1, further including applying the anti-sticking and anti-icing agent to the aggregate material before it is stored in a stock pile for subsequent loading into the aggregate material hauling equipment.

9. The method of claim 8, further including also applying the anti-sticking and anti-icing agent to the aggregate material during transfer from the stockpile to the aggregate material hauling equipment.

10. The method of claim 9, further including also applying the anti-sticking and anti-icing agent to the aggregate material after loading into the aggregate material hauling equipment.

11. The method of claim 1, further including applying the anti-sticking and anti-icing agent to the aggregate material during transfer from the stockpile to the aggregate material hauling equipment.

12. The method of claim 1, further including initiating loading of the aggregate material into the aggregate material hauling equipment while the hauling surfaces of the hauling equipment remain wet from the applying of the anti-sticking and anti-icing agent.

13. The method of claim 1, further including initiating loading of the aggregate material into the aggregate material hauling equipment within five minutes of the applying of the anti-sticking and anti-icing agent.

14. The method of claim 1, further including initiating loading of the aggregate material into the aggregate material hauling equipment within one minute of the applying of the anti-sticking and anti-icing agent.
